(19) United States
(12) Patent Application Publication
(10) Pub. No.: US 2025/0165578 A1
(43) Pub. Date: May 22, 2025

(54) SYSTEM AND METHOD FOR PROVIDING AUTHENTICATION SERVICE BY USING OPEN BADGE LINKED TO BLOCKCHAIN-BASED ACADEMIC ACHIEVEMENT

(71) Applicant: SWEMPIRE CO., LTD., Goyang-si (KR)

(72) Inventor: Myoung Soo CHOI, Goyang-si (KR)

(73) Assignee: SWEMPIRE CO., LTD., Goyang-si (KR)

(21) Appl. No.: 18/916,119

(22) Filed: Oct. 15, 2024

(30) Foreign Application Priority Data
Nov. 20, 2023 (KR) 10-2023-0161536

(51) Int. Cl. G06F 21/34; G06F 21/32; G06Q 20/36

(52) U.S. Cl. CPC G06F 21/34; G06F 21/32; G06Q 20/36

(57) ABSTRACT

Disclosed are a device and a method for providing an issuance service by using an open badge linked to blockchain-based academic achievement that reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

### CROSS-REFERENCE TO RELATED APPLICATIONS

A claim for priority under 35 U.S.C. § 119 is made to Korean Patent Application No. 10-2023-0161536 filed on Nov. 20, 2023 in the Korean Intellectual Property Office, the entire contents of which are hereby incorporated by reference.

### BACKGROUND

Embodiments of the present disclosure described herein relate to a device and a method for providing an authentication service using an open badge, and more particularly, relate to a system and a method for providing an authentication service by using an open badge linked to blockchain-based academic achievement.

With the development of Internet services, most people use, through the Internet, numerous online services such as government institutions, educational institutions, medical institutions, telecommunication companies, financial companies, passenger companies, asset management, credit information, portals, social network services (SNS), games, shopping, ticketing, courier, electronic voting, etc.

Accordingly, users who intend to utilize these services need to sign up as members by entering personal information, including their real name, or to authenticate themselves as registered users by entering a specific ID and a password. However, because it is quite cumbersome to repeat these authentication processes at a plurality of sites, a method called simple authentication has been recently developed to easily conduct financial transactions on the Internet by logging in easily.

User authentication has been conventionally performed by using a centralized identify (ID) system. Generally, a public certificate and program Active X for using the public certificate or a separate application (App) for performing authentication has been installed, and then authentication has been made through the program or application.

However, personal information may be leaked or abused in the centralized identity verifying system.

Moreover, when the user's identity is verified by using the program or application, a separate program needs to be installed. Besides, a new authentication application or a new authentication program may not be compatible with existing applications or programs, and thus the user identity may not be smoothly verified.

Nowadays, a decentralized identifiers (DID) technology, which allows users to verify their identities through an issuer, is attracting attention.

In the meantime, an open badge is nowadays emerging as a new digital credentialing method using a blockchain technology. The open badge includes metadata of each individual's learning history, skills, knowledge, honor, experience, and capabilities in a unique image. The reliability of results may be improved by capturing and recognizing a wide range of learning results and verifying them by using a blockchain. In other words, the open badge is a standardized framework capable of sharing a badge, and has qualifications for evaluation, issuance security, and authentication system, thereby securing the reliability of proof.

Accordingly, there is a need to develop a technology that provides an open badge linked to a study such that users (learners) are able to prove their qualifications obtained through education, learning, examinations, etc. provided by educational institutions (learning institutions), and to utilize the open badge easily.

### SUMMARY

Embodiments of the present disclosure provide a system and a method for providing an authentication service by using an open badge linked to blockchain-based academic achievement that may reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

Embodiments of the present disclosure provide a system and a method for providing an authentication service by using an open badge linked to blockchain-based academic achievement that may allow a user to easily check the user's fragmented history data by integrating and managing at least one open badge issued to the user, and may allow the user to post the fragmented history data to at least one SNS, thereby quickly and easily utilize the history data for employment or advancement.

Problems to be solved by the present disclosure are not limited to the problems mentioned above, and other problems not mentioned will be clearly understood by those skilled in the art from the following description.

According to an embodiment, an authentication service providing system by using an open badge linked to a blockchain-based academic achievement includes a first institutional terminal that provides a learning service to a user terminal, and creates or updates history information about a corresponding user by receiving learning performance result information from the user terminal, the user terminal that performs learning through a learning service provided by the first institutional terminal, stores an open badge issued as making a request for open badge issuance for the learning to a service server, and requests qualification recognition by submitting the stored open badge to a second institutional terminal, the service server that determines whether the corresponding user has an issuance qualification for the open badge requested to be issued, when the open badge issuance is requested from the user terminal, determines whether to issue the open badge, and records and manages the issued open badge in a decentralized identifiers (DID) electronic wallet of the corresponding user registered in a blockchain, and the second institutional terminal that determines whether the corresponding user is qualified for the learning, by requesting the service server to verify a submitted open badge when the stored open badge is submitted from the user terminal. The service server recommends other learning, which is related to the open badge previously issued to the user, to the user terminal such that the user is capable of receiving an additional open badge. The open badge includes necessary metadata and optional metadata. The necessary metadata includes verification uniform resource locator (URL) information. The optional metadata includes evidence URL information, information about a possibility of integration with another badge, other service purpose information, information about prerequisite learning requirements for course registration, information about connectivity with another course, and information about a characteristic of a qualification created by integration with another course.

According to an embodiment, a method for providing an authentication service by using an open badge linked to blockchain-based academic achievement includes transmitting, by a user terminal, learning performance result information about the learning to the first institutional terminal when a corresponding user completely performs learning based on a learning service provided by a first institutional terminal, creating or updating, by the first institutional terminal, history information about the corresponding user based on the learning performance result information, determining, by a service server, whether the corresponding user has an issuance qualification for an open badge requested to be issued, through the first institutional terminal when an open badge issuance request for the learning is received from the user terminal, issuing, by the service server, an open badge for the learning based on badge issuance data for the corresponding user when the determination result indicates that the corresponding user has the issuance qualification for the open badge requested to be issued, recording and managing, by the service server, the issued open badge in a DID electronic wallet of the corresponding user registered on a blockchain, and performing, by the service server, verification on the issued open badge based on the DID electronic wallet of the corresponding user when a verification request for the issued open badge is received from a second institutional terminal. The issuing of the open badge includes recommending, by the service server, other learning, which is related to an open badge previously issued to the user, to the user terminal such that the user is capable of receiving an additional open badge. The open badge includes necessary metadata and optional metadata. The necessary metadata includes verification URL information. The optional metadata includes evidence URL information, information about a possibility of integration with another badge, other service purpose information, information about prerequisite learning requirements for course registration, information about connectivity with another course, and information about a characteristic of a qualification created by integration with another course.

Besides, a computer program stored in a computer-readable recording medium for executing a method to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram showing a network structure of a system for providing an authentication service by using an open badge linked to blockchain-based academic achievement, according to an embodiment of the present disclosure;

FIG. 2 is a diagram showing a procedure for providing an authentication service by using an open badge linked to blockchain-based academic achievement, according to an embodiment of the present disclosure;

FIG. 3 is a flowchart showing an operation of a system for providing an authentication service by using an open badge linked to blockchain-based academic achievement, according to an embodiment of the present disclosure;

FIG. 4 is a diagram for describing a concept of an open badge linked to blockchain-based academic achievement, according to an embodiment of the present disclosure;

FIG. 5 is a diagram showing a configuration of a service server for providing an authentication service by using an open badge linked to blockchain-based academic achievement, according to an embodiment of the present disclosure;

FIG. 6 is a flowchart illustrating a method for providing an authentication service by using an open badge linked to blockchain-based academic achievement, according to an embodiment of the present disclosure;

FIG. 7 is a diagram showing a specific operation of issuing an open badge in a method for providing an authentication service by using an open badge linked to blockchain-based academic achievement, according to an embodiment of the present disclosure;

FIG. 8 is a diagram showing a specific operation of issuing an open badge in a method for providing an authentication service by using an open badge linked to blockchain-based academic achievement, according to an embodiment of the present disclosure;

FIGS. 9A to 9E are drawings showing examples of a screen displayed on a display of a user terminal performing a user registration procedure to receive an authentication service using an open badge linked to blockchain-based academic achievement, according to an embodiment of the present disclosure;

FIGS. 10A to 10E are drawings showing a specific operation of issuing an open badge in a method for providing an authentication service by using an open badge linked to blockchain-based academic achievement, according to an embodiment of the present disclosure;

FIGS. 11A to 11E are drawings showing an example of a screen displayed on a display of a user terminal so as to identify a status of a DID electronic wallet of a corresponding user created on a blockchain, according to an embodiment of the present disclosure;

FIG. 12 is a diagram showing an example of utilizing an open badge linked to blockchain-based academic achievement, according to an embodiment of the present disclosure;

FIG. 13 is a diagram showing a structure of a DID electronic wallet registered in a blockchain, according to an embodiment of the present disclosure; and

FIG. 14 is a drawing showing an example of a dashboard for a corresponding user displayed in a portfolio format on a display of a user terminal, according to an embodiment of the present disclosure.

### DETAILED DESCRIPTION

The above and other aspects, features and advantages of the present disclosure will become apparent from the following description of the following embodiments given in conjunction with the accompanying drawings. The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to those skilled in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

Unless otherwise defined, all terms (including technical and scientific terms) used herein have the same meaning as commonly understood by those skilled in the art to which the present disclosure pertains. Moreover, terms, such as those defined in commonly used dictionaries, should not be interpreted in an idealized or overly formal sense unless expressly so defined herein.

The same reference numerals denote the same elements throughout the present disclosure. The present disclosure does not describe all elements of embodiments. Well-known content or redundant content in which embodiments are the same as one another will be omitted in a technical field to which the present disclosure belongs. The term “unit” or “module” used herein may refer to software or hardware such as field programmable gate array (FPGA) or application specific integrated circuit (ASIC), and the “unit” or “module” may perform some functions. However, the “unit” or “module” may be not limited to software or hardware. The “unit” or “module” may be configured to exist in an addressable storage medium or may be configured to operate one or more processors. Therefore, as an example, “units” or “module” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” or “modules” and elements may be combined into a smaller number of “units” or “modules” and elements or may be divided into additional “units” or “modules” and elements.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, definitions of terms used in the description are as follows.

In the present disclosure, the description is limited to a service server 300. However, the present disclosure may further include a server, a computer, and/or a portable terminal, or may be in a form of any one thereof.

Here, the server may be a server that processes information by communicating with an external device and may include an application server, a computing server, a database server, a file server, a game server, a mail server, a proxy server, and a web server.

For example, the computer may include a notebook computer, a desktop computer, a laptop computer, a tablet PC, a slate PC, and the like, which are equipped with a web browser.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet terminal (Wibro) terminal, and a wearable device such as a timepiece, a ring, a bracelet, an anklet, a necklace, glasses, a contact lens, or a head-mounted device (HMD).

Hereinafter, operating principles and embodiments of the present disclosure will be described with reference to the accompanying drawings.

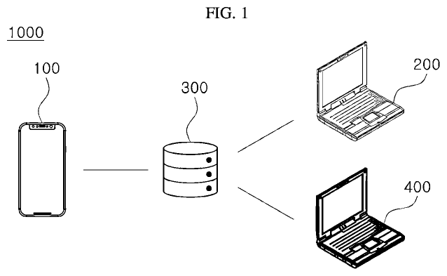

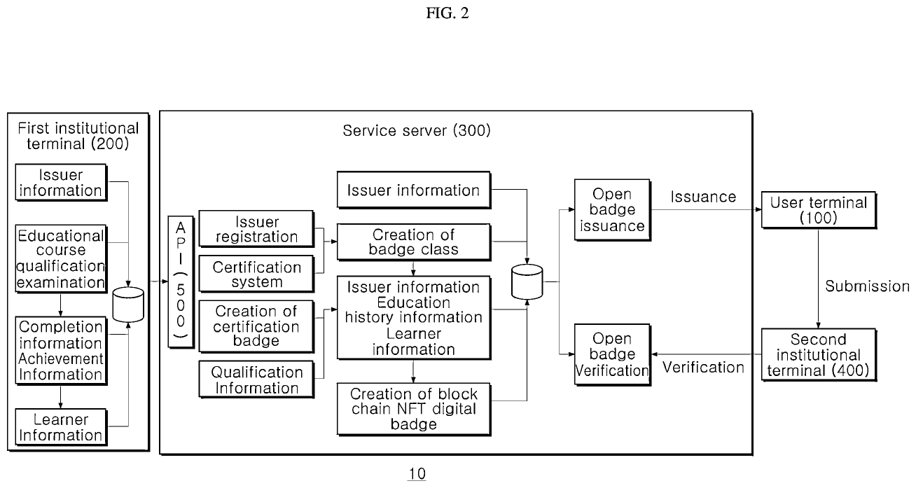

FIG. 1 is a diagram showing a network structure of a system for providing an authentication service by using an open badge linked to blockchain-based academic achievement, according to an embodiment of the present disclosure. FIG. 2 is a diagram showing a procedure for providing an authentication service by using an open badge linked to blockchain-based academic achievement, according to an embodiment of the present disclosure.

Referring to FIG. 1, a system (hereinafter referred to as a “providing system”) for providing an issuance service by using an open badge linked to blockchain-based academic achievement according to an embodiment of the present disclosure may include a user terminal 100, a first institutional terminal 200, a service providing device (hereinafter referred to as a “providing device”) 300, and a second institutional terminal 400. Here, the one first institutional terminal 200 the one second institutional terminal 400 are described, but this is only for convenience of description. The number or type thereof is not limited thereto. In the meantime, for convenience of description, a learning institution is described by way of example. However, the present disclosure may be applied to, but is not limited to, any other organization that provides users with courses for obtaining qualifications for learning, education, work, or the like.

The user terminal 100 is a terminal of a user (recipient) who obtains qualifications related to learning, education, work, or the like, by performing the learning, the education, the work, or the like, which is provided by at least one first institution based on the first institutional terminal 200. To receive an authentication service by using an open badge linked to blockchain-based academic achievement, the user terminal 100 registers an issuer's distributed ID information on a blockchain (trusted ID storage) through the service server 300 (i.e., DID user registration). In this case, when DID user registration is performed, a user (i.e., a user's identity) may be verified through one of a plurality of authentication methods while the initial distributed ID is issued. Here, the plurality of authentication methods may correspond to integrated authentication and may include at least one of biometric authentication, PIN numbers, and patterns.

In the meantime, when a user holding the user terminal 100 obtains qualifications and then requests the service server 300 to issue an open badge including the assertion of performance information as a result of the performance of learning, education, work, or the like provided by the first institutional terminal 200, the open badge is issued from the service server 300 in response to the request. Meanwhile, the issued open badge may be presented or displayed to the second institutional terminal 400, which is a demanding terminal, at the request of the user terminal 100.

In the meantime, the first institutional terminal 200 may be a device or server equipped (installed) in a learning institution, and may provide a separate web page or platform (application) to provide the learning service. In other words, the first institutional terminal 200 may build and provide a separate web page or platform (application), the first institutional terminal 200 provides the requested learning service to the at least one user terminal 100 registered for the learning service based on the web page or platform.

The first institutional terminal 200 stores and manages not only the user's user information, but also history information about learning. Here, the user information may include at least one of a user's name, age, gender, address, contact information, and academic background. The history information may include at least one of login information including a login history, admission information (year of admission, department, student number, etc.), major information, lecture information (semester information, lecture codes, classification codes, course registration information, curriculum, lecture content, completion statuses, credits earned, etc.), learning course information (student numbers, course codes, completion statuses, etc.), inquiry information (question name/question content, response name/response content, etc.), assignment information, grade information, and evaluation information (evaluation results of proficiency, ability, talent, etc.) about the user.

Moreover, the first institutional terminal 200 provides the corresponding learning service at the request of the user terminal 100. When the user completes the learning course for a specific learning through the user terminal 100, the first institutional terminal 200 receives the learning performance result and then grants the user the qualification corresponding to the learning course. In this case, on the basis of the learning performance result, the first institutional terminal 200 may newly create history information about the user or may update the existing history information.

Accordingly, when the user terminal 100, the service server 300, and the second institutional terminal 400 are directly or indirectly requested to identify the eligibility of the user or to identify the eligibility for receiving an open badge, the first institutional terminal 200 may identify and answer the eligibility based on the user information and the history information. In this case, the first institutional terminal 200 may determine whether the corresponding user satisfies requirements for obtaining an open badge, based on the pre-stored criteria. When the requirements are satisfied, the first institutional terminal 200 may provide the service server 300 with badge issuance data obtained by extracting some history information from the history information. However, this is only an example, and the history information about the user may be provided as it is to the service server 300 without the need to extract the badge issuance data from the history information.

Here, the at least one or more first institutional terminals 200 may be provided. While each of the first institutional terminals 200 is linked (connected) to the service server 300 through an application programming interface (API), the system, format, or the like for qualifications, certificates, or the like that is capable of being issued by each first institution (a learning institution, an educational institution, or the like) may be stored together.

In the meantime, the service server 300 may perform an operation of managing badge issuance data, registering and managing a badge issuance institution, providing a badge standard guide, building a badge operating framework, verifying a badge issuance institution and a badge issuance history, and providing badge issuance data information. Here, the badge issuance data may be data for badge issuance, and may be data extracted from the history information stored and managed by the first institutional terminal 200. However, this is only one example, and the service server 300 may receive the user's history information as it is, and is not limited thereto.

The service server 300 issues an open badge based on the badge issuance data or the history information, and then registers the badge issuance data on a blockchain so as to be registered. In this case, the badge issuance data or the history information includes a public key used to sign the assertion of the first institutional terminal 200. The public key may be used later for DID verification. Additionally, the service server 300 may revoke an open badge. In this case, the required method of revoking an open badge differs based on whether the assertion is a hosted assertion or a signed assertion.

In the meantime, when issuing an open badge, the service server 300 issues the open badge by identifying (measuring) at least one of the corresponding user's learning chunks, proficiency, competency, and talent based on the badge issuance data or the history information.

In other words, the open badge may include metadata such as the user's performance and competency within the badge image, and may be verified anytime, anywhere. Here, the metadata may be recorded on a conventional digital badge and may be based on the minimum metadata. For example, necessary metadata may include at least one of first institution data (an issuer name, an issuer address, an issuer description, whether the issuer is accredited, or the like), a badge class (the name of a course, whether the course is accredited, the feature/level of the accredited course, a course category, nature/level of the course, completion/qualification acquisition criteria, a qualification quality assurance type, or the like), acquisition data (completion/acquisition qualification, badge issuance date, badge expiration date, assessment type, a learning activity participation type, or the like), an earner (an earner name, earner information, or the like), and verification information (verification URL, or the like). Optional metadata may include at least one of additional information about an issuer, course completion criteria/cycles, evidence URL, withdrawal/reasons for withdrawal, a possibility of integration with other badges, other service purpose information, prerequisite learning requirements for course registration, assessment courses, scores earned, connectivity with other courses, characteristics of a qualification created by integration/accumulation with other courses, and a location on a learning portfolio/career path.

When there is a request from an earner or demander due to the closure of the issuer or the loss or damage of data, the metadata may be used to verify the metadata.

Besides, the service server 300 stores and searches for smart contract-based blockchain data for an open badge. In this case, data search performance may be improved by generating actual data blocks in one file format by using a data block allocation table linked to a data registration transaction, and caching meta information of data and the data block allocation table. Furthermore, the data search performance may be improved by generating actual data blocks into one file by using a data block allocation table linked to a data registration transaction, and caching data meta information and the data block allocation table. To this end, data may be encrypted based on unique information generated by the smart contract, and the encrypted data may be applied such that a decryption key is automatically obtained depending on access control permissions.

To this end, the service server 300 may build and provide a separate web page or platform (application). Each device (a user terminal, an issuing institutional terminal, a demand institutional terminal, or the like) registered for an authentication service may receive the authentication service by using an open badge linked to a blockchain-based academic achievement based on the web page or platform (application).

This web page or platform may be implemented on a dashboard for each user. At least one open badge (i.e., DID status) issued to each user may be configured on the dashboard in the form of a portfolio. In this way, the user may identify various types of information about at least one open badge issued to him/her through his/her DID status by executing a web page or platform through the user terminal 100.

In addition, the service server 300 may perform DID registration, open badge issuance, DID verification, or the like on a user based on an API 500 previously linked.

In the meantime, the second institutional terminal 400 may be a device (terminal) installed in a consumer. When the open badge is submitted or displayed from the user terminal 100, the second institutional terminal 400 may request the service server 300 to verify an assertion, which is digitally signed in the open badge, based on a public key such that DID verification is performed.

Accordingly, when the verification from the service server 300 is completed, it may be determined whether to accredit the user's qualification for the open badge, based on the verification result.

In the meantime, the user terminal 100, the first institutional terminal 200, and the second institutional terminal 400 may be a computer, an ultra-mobile PC (UMPC), a workstation, a net-book, personal digital assistants (PDA), a portable computer, a web tablet, a wireless phone, a mobile phone, a smart phone, a pad, a smart watch, a wearable terminal, an e-book, a portable multimedia player (PMP), a portable game console, a navigation device, a black box or digital camera, other mobile communication terminals, or the like, on which a user/a first institution (an educational institution, a learning institution, or the like)/a consumer (a demander, a submission agency, or the like) is capable of installing and executing a plurality of desired application programs (i.e., applications). In this case, the user terminal 100, the first institutional terminal 200, and the second institutional terminal 400 may be provided in various forms and is not limited thereto.

As described above, a service providing system 10 according to an embodiment of the present disclosure may be implemented through data transmission and reception between the user terminal 100, the first institutional terminal 200, the service server 300, and the second institutional terminal 400.

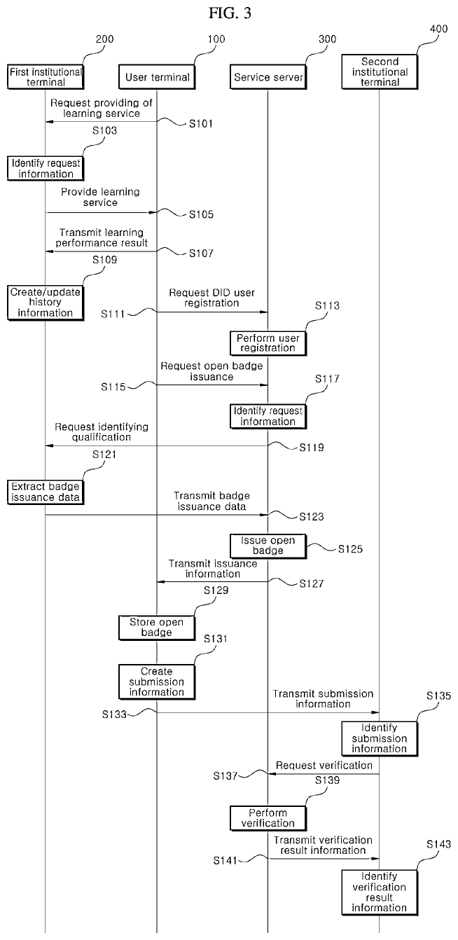

FIG. 3 is a flowchart showing an operation of a system for providing an authentication service by using an open badge linked to blockchain-based academic achievement, according to an embodiment of the present disclosure.

Referring to FIG. 3, the user terminal 100 transmits a learning service providing request to the first institutional terminal 200 to receive a learning service by a first institution (S101). In this case, the learning service providing request may be a request for subscribing to the learning service when a user is a new user. When the user is an existing subscribed user, the learning service providing request may be a request for providing specific learning among at least one learning service.

Next, the first institutional terminal 200 identifies request information in step S101 (S103). After the first institutional terminal 200 determines whether to provide the learning service by determining whether the user has access permissions, the first institutional terminal 200 provides the requested learning service only to the accessible user (S105).

Next, the user terminal 100 performs the learning service provided by the first institutional terminal 200. When the corresponding learning service is completely performed, the user terminal 100 transmits the learning performance result to the first institutional terminal 200 (S107).

Next, on the basis of the learning performance result received in step S107, the first institutional terminal 200 newly creates history information for the corresponding user or updates the previously created history information (S109).

Afterward, the user terminal 100 transmits a DID user registration request to the service server 300 to receive an authentication service using an open badge linked to blockchain-based academic achievement (S111), and the service server 300 performs DID user registration by registering the user's distributed ID information on the trusted ID storage (i.e., a blockchain) (S113). In this case, a DID electronic wallet for the corresponding user may be created.

Next, when the user terminal 100 intends to receive an open badge, the user terminal 100 transmits the open badge issuance request to the service server 300 (S115). In this case, although not shown in FIG. 3, when the user terminal 100 requests open badge issuance, the user terminal 100 may receive at least one open badge, which is capable of being issued by the service server 300, in a list form (hereinafter referred to as an “issuable open badge list’) from the service server 300. In other words, a user may transmit an issuance request for any open badge by selecting the open badge from the list. To this end, the service server 300 may perform an operation of registering the at least one first institutional terminals 200 in advance, and may identify at least one open badge, which is capable of being issued to each user, through history information of each user from the registered at least one first institutional terminals 200. In the meantime, in another embodiment, the service server 300 may support the acquisition of additional open badge issuance qualifications by recommending issuing an issuable open badge in addition to the open badge requested by the user, or recommending other learning related to the previously issued open badge.

Next, the service server 300 identifies the request information in step S115 (S117), transmits a request for a qualification check to the first institutional terminal 200, and requests the first institutional terminal 200 to identify the user's qualification for the open badge for which the issuance is requested (S119).

Next, the first institutional terminal 200 identifies the user's history information depending on the request in step S119, extracts data (i.e., badge issuance data) for issuing a badge from the history information (S121), and transmits the badge issuance data to the service server 300 (S123).

Next, the service server 300 issues the open badge, of which the issuance is requested, based on the badge issuance data obtained in step S123 (S125) and transmits issuance information including the issued open badge to the user terminal 100 (S127).

Accordingly, the user terminal 100 may store the open badge included in the issuance information (S129) and may post the open badge on at least one SNS installed on the user terminal 100 as needed.

Afterward, the user terminal 100 generates submission information including the open badge stored in step S129 (S131) to submit the open badge corresponding to the corresponding qualification to a second institution, by which the user desires to be credentialed, and transmits the submission information to the second institutional terminal 400 (S133).

Next, the second institutional terminal 400 identifies the submission information (S135), and requests the service server 300 to verify the open badge included in the submission information (S137).

Accordingly, the service server 300 verifies the open badge depending on the request in step S137 (S139), and generates verification result information including the verification result and transmits the verification result information to the second institutional terminal 400 (S141).

Next, the second institutional terminal 400 determines whether to credential the user's qualification by identifying the verification result information received in step S141 (S143).

FIG. 4 is a diagram for describing a concept of an open badge linked to blockchain-based academic achievement, according to an embodiment of the present disclosure.

An open badge 600 may be issued, obtained, and managed through an open badge platform that supports an open badge standard. As shown in FIG. 4, the open badge 600 includes information about content of guaranteed skills, issuer information, user information thus obtained and displayed, expiration date, a method for verification, or the like. The open badge 600 may also be approached from an ecological perspective. Major stakeholders may be classified into three types: an issuance institution that issues the open badge 600, a user that obtains the badge, and a company that develops an open badge platform.

First of all, the open badge 600 determines whether to be issued, as qualifications are assigned by a learning institution. The learning institution may divide learning into small chunks to provide the small chunks to a user, may credential the learning based on proficiency, may grant an issuance qualification for the open badge as a means of recognition for microcredentials, and may measure and maintain the user's abilities (talent, qualifications).

Moreover, the user who receives the open badge 600 may submit (present) the open badge as evidence of the skills or academic achievements, which he/she has learned, to go on to an advanced school or to find a job, may collect the open badge 600 in a portfolio or backpack to provide a notification of his/her story when the open badge is issued to the user, and may share his/her open badge 600 with social media or the community. That is, the open badge 600 may be posted on at least one SNS at the request of the user terminal 100.

Moreover, the company that is going to find business opportunities may design a system capable of recognizing and verifying small chunks of learning provided by learning institutions, may develop a tool for tracking the user's engagement levels, extending resources, creating the open badge 600, and displaying/hosting the open badge, may apply an open badge standard, and may obtain conformity certification.

Meanwhile, the open badge 600 may include an issuer, a badge class, and an assertion. Here, the assertion may include performance information about the history performed by the corresponding user.

FIG. 5 is a diagram showing a configuration of a service server for providing an authentication service by using an open badge linked to blockchain-based academic achievement, according to an embodiment of the present disclosure.

Referring to FIG. 5, according to an embodiment of the present disclosure, the service server 300 that provides an authentication service by using an open badge linked to blockchain-based academic achievement may include a communication module 310, a storage module 320, and a processor 330.

The communication module 310 may perform wired or wireless communication with the user terminal 100, the first institutional terminal 200, the second institutional terminal 400, and at least one external device (a server, etc.). In particular, when the wireless communication is performed, wireless signals are exchanged over a communication network based on wireless Internet technologies.

The communication module 310 may include one or more components that enable communication with an external device. The communication module 310 may include, for example, at least one of a wired communication module, a wireless communication module, and a short-range communication module, and may transmit and receive signals based on the at least one communication module.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard (RS-232), power line communication, or plain old telephone service (POTS).

In addition to a Wifi module and a Wireless broadband (WiBro) module, the wireless communication module may include a wireless communication module that supports various wireless communication methods such as global System for Mobile Communication (GSM), Code Division Multiple Access (CDMA), Wideband Code Division Multiple Access (WCDMA), universal mobile telecommunications system (UMTS), Time Division Multiple Access (TDMA), Wireless LAN (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), 4G, 5G, 6G, or the like.

The short-range communication module may be used for short range communication, and may support short-range communication by using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB) technologies.

In particular, the communication module 310 may receive a request for issuance, authentication, or the like of an open badge from each of the user terminal 100, the first institutional terminal 200, and the second institutional terminal 400 based on wired or wireless communication and may transmit the result for the request. Furthermore, various types of information for issuing and authenticating the open badge may be exchanged with the user terminal 100, the first institutional terminal 200, and/or the second institutional terminal 400 through the communication module 310. In addition, the communication module 310 exchanges various types of information with at least one external device.

The storage module 320 stores data and/or various types of information for supporting various functions of the service server 300. The storage module 320 may store a plurality of application programs (or applications) running in the service server 300, data for an operation of the service server 300, and instructions. At least part of the application programs may be downloaded from an external server through wireless communication. In the meantime, the application program may be stored in at least one memory provided in the storage module 320, may be installed in the service server 300, and may be driven so as to perform an operation (or function) executed by at least one processor provided in the processor 330.

In the meantime, the at least one memory may include a storage medium of at least one type of a flash memory type, a hard disk type, a multimedia card micro type, a card type memory (e.g., SD memory, XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, etc. Besides, the memory may store information temporarily, permanently, or semi-permanently, and may be provided in an embedded type or a removable type.

The storage module 320 may establish and store a database for providing an authentication service by using an open badge linked to blockchain-based academic achievement. The database may store various types of information about at least one respective user (a user, an educational institution, a receiving institution, or the like) subscribed to the authentication service. Moreover, the storage module 320 may store at least one process for providing the authentication service by using an open badge linked to blockchain-based academic achievement.

The processor 330 may include at least one processor for providing the authentication service by using an open badge linked to blockchain-based academic achievement. The processor 330 may allow all components within the service server 300 to process signals, data, information, or the like, which is input or output, or may perform various processes by executing commands, algorithms, and application programs stored in at least one memory.

That is, all operations performed by the service server 300 described above based on FIGS. 1 and 2 may be performed under control of the processor 330.

In detail, when a DID user registration request is received from the user terminal 100, the processor 330 performs DID registration on a blockchain by verifying user identity through integrated authentication (biometric authentication, PIN number, and patterns) while issuing a first distributed ID.

In the meantime, when an open badge issuance request for the corresponding user is received from the user terminal 100, after the processor 330 performs user authentication by accessing a distributed ID based on one of a plurality of authentication methods, the processor 330 provides an issuable open badge list including at least one issuable open badge for the corresponding user. When one of the open badges is selected from the issuable open badge list, the processor 330 issues an open badge by identifying and combining the history data and format based on a DID electronic wallet of the corresponding user registered in the blockchain.

Moreover, when a DID verification request for a previously issued open badge is received from the user terminal 100 or the second institutional terminal 400, the processor 330 performs user authentication by accessing the distributed ID based on one of the plurality of authentication methods and performs DID verification on the previously issued open badge based on the DID electronic wallet of the corresponding user registered in the blockchain.

In this case, when the processor 330 performs DID verification, the processor 330 may verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

The processor 330 may perform DID verification based on the linked API.

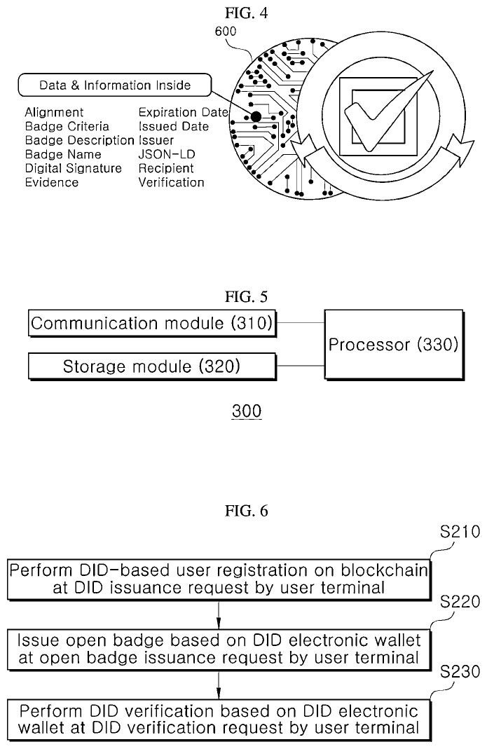

FIG. 6 is a flowchart illustrating a method for providing an authentication service by using an open badge linked to blockchain-based academic achievement, according to an embodiment of the present disclosure.

Referring to FIG. 6, a user performs DID user registration on a blockchain to the service server 300 by transmitting a DID user registration request by using the user terminal 100 to receive an authentication service by using an open badge linked to blockchain-based academic achievement (S210).

Next, when the user terminal 100 requests the issuance of an open badge by selecting an issuance item, the service server 300 issues the open badge based on a DID electronic wallet of the corresponding user through the linked API (S220).

Next, when a DID verification request for the open badge thus previously issued is received from the user terminal 100 or the second institutional terminal 400, the service server 300 performs DID verification on the open badge based on the DID electronic wallet of the corresponding user through the previously linked API (S230).

In the meantime, although not shown in FIG. 6, the service server 300 may register at least one issuer in or before step S210. In this case, the system, format, or the like for qualifications, certificates, or the like credentialed by each first institution may be stored together.

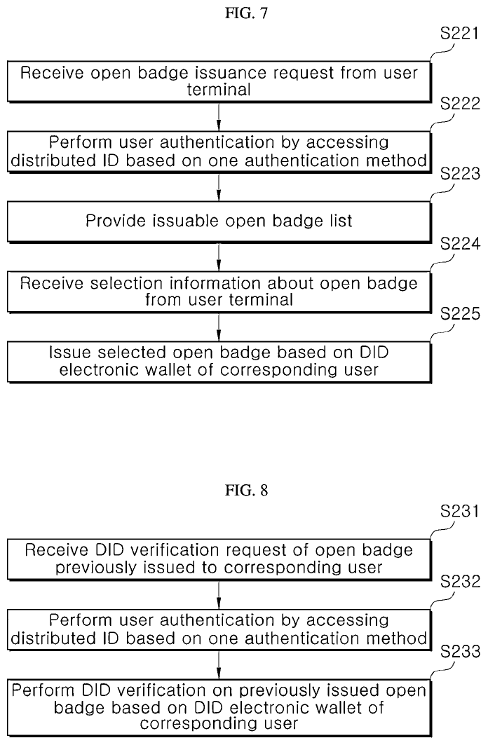

FIG. 7 is a diagram showing a specific operation of issuing an open badge in a method for providing an authentication service by using an open badge linked to blockchain-based academic achievement, according to an embodiment of the present disclosure.

Referring to FIG. 7, when an open badge issuance request for the corresponding user is received from the user terminal 100 (S221), the service server 300 performs user authentication by accessing a distributed ID based on one of a plurality of authentication methods (S222).

Next, the service server 300 provides an issuable open badge list including at least one issuable open badge for the corresponding user (S223). When selection information generated as a user selects one open badge from the issuable open badge list is received through the user terminal 100 (S224), the service server 300 issues the selected open badge by identifying and combining the history data and format based on a DID electronic wallet of the corresponding user, which is registered in a blockchain (S225).

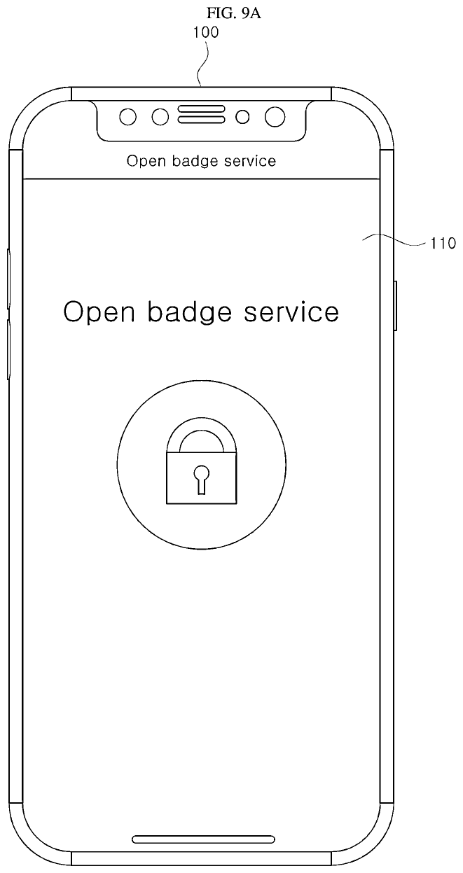

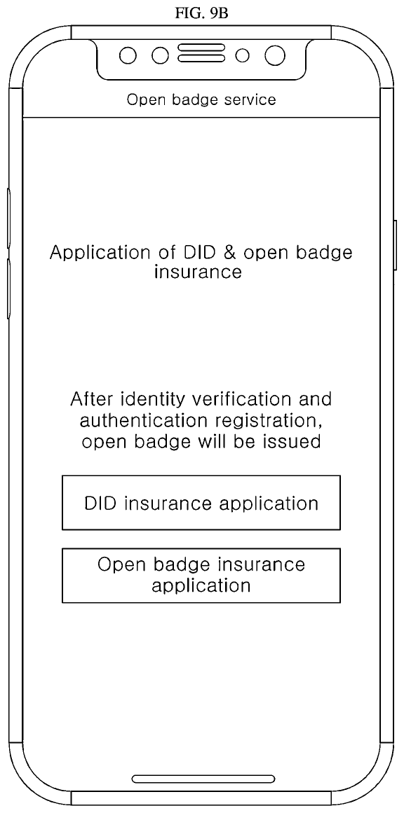

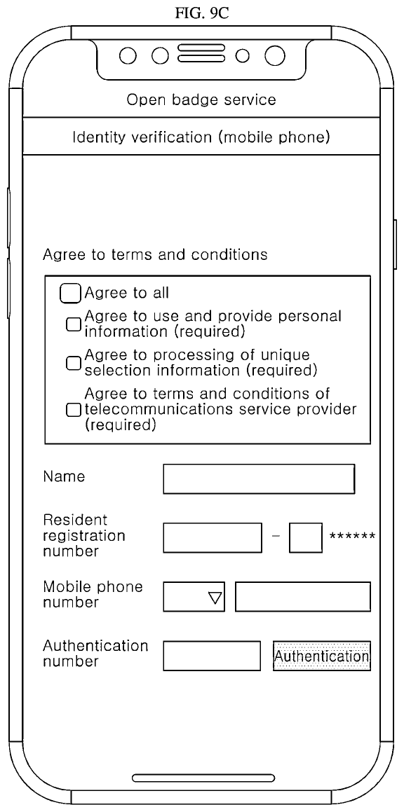

FIG. 8 is a diagram showing a specific operation of issuing an open badge in a method for providing an authentication service by using an open badge linked to blockchain-based academic achievement, according to an embodiment of the present disclosure.

Referring to FIG. 8, when a DID verification request for an open badge previously issued to the corresponding user is received from the user terminal 100 or the second institutional terminal 400 (S231), the service server 300 performs user authentication by accessing a distributed ID based on one of a plurality of authentication methods (S232).

Next, the service server 300 performs DID verification on the previously issued open badge, for which verification is requested in step S231, based on a DID electronic wallet of the corresponding user, which is registered in a blockchain (S233).

In this case, step S233 may be used to verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

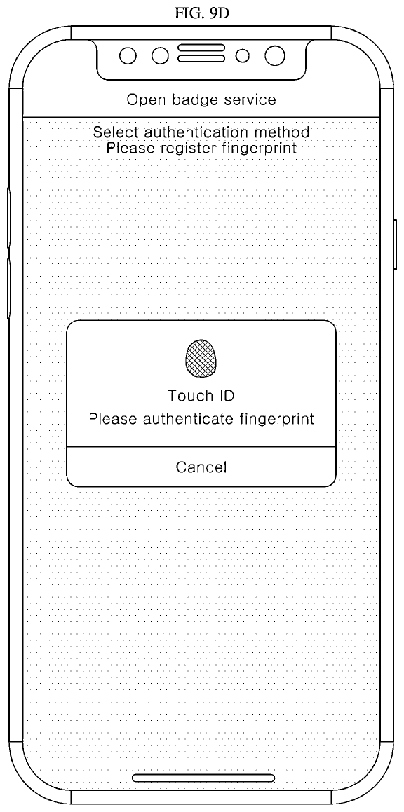

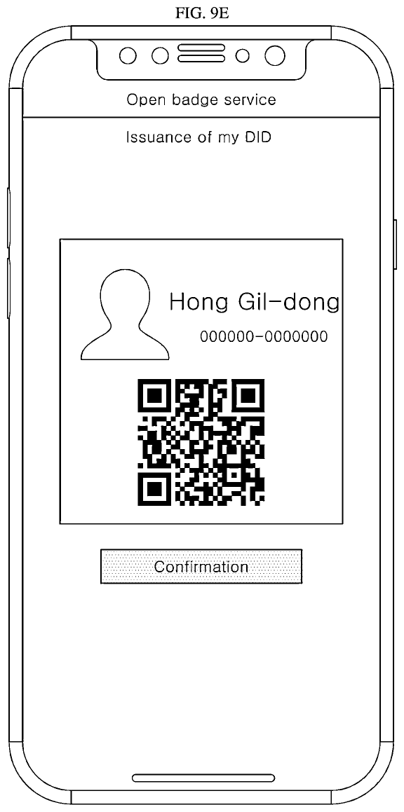

FIGS. 9A to 9E are drawings showing examples of a screen displayed on a display of a user terminal performing a user registration procedure to receive an authentication service using an open badge linked to blockchain-based academic achievement, according to an embodiment of the present disclosure.

Referring to FIGS. 9A to 9E, as illustrated in FIG. 9A, a user launches a separate web page or application through the user terminal 100 to use an authentication service by using a blockchain DID-based open badge. Accordingly, as illustrated in FIG. 9B, an activated button may be displayed on a display 110 of the user terminal 100 so as to request DID issuance or open badge issuance for the corresponding user.

As illustrated in FIG. 9C, a user interface is implemented to allow the user to enter at least one piece of personal information for identity verification when the user selects a DID issuance application button. As illustrated in FIG. 9D, the user may perform authentication registration by selecting at least one authentication method among a plurality of authentication methods as the input is completed.

Accordingly, as user registration/authentication is completed, DID issuance for the user may be performed as illustrated in FIG. 9E.

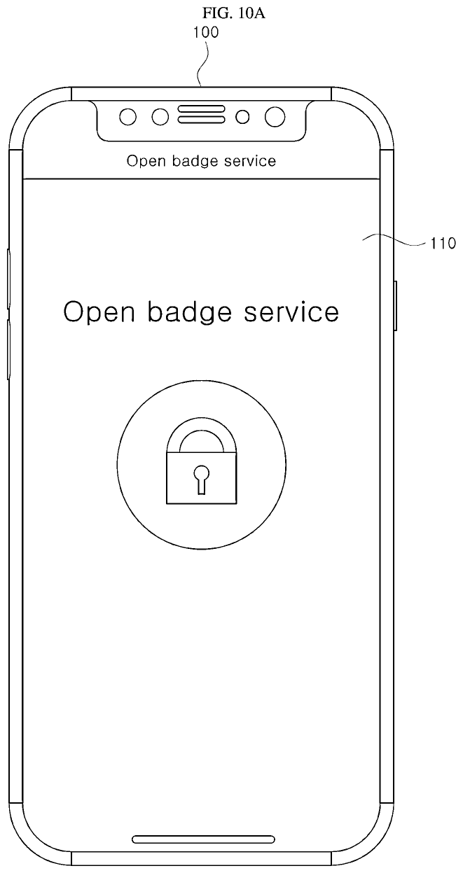

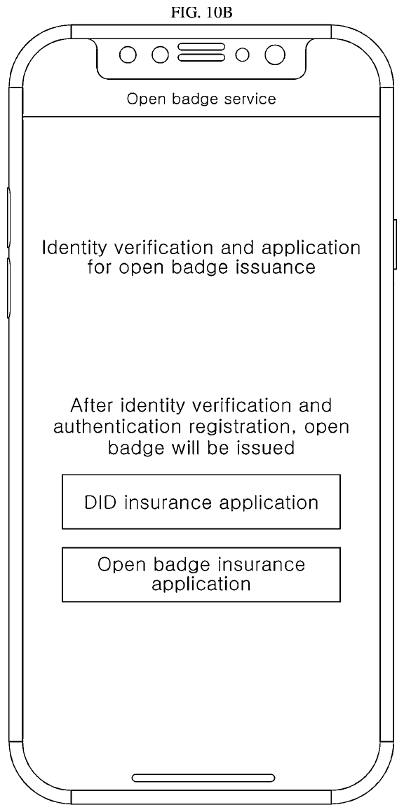

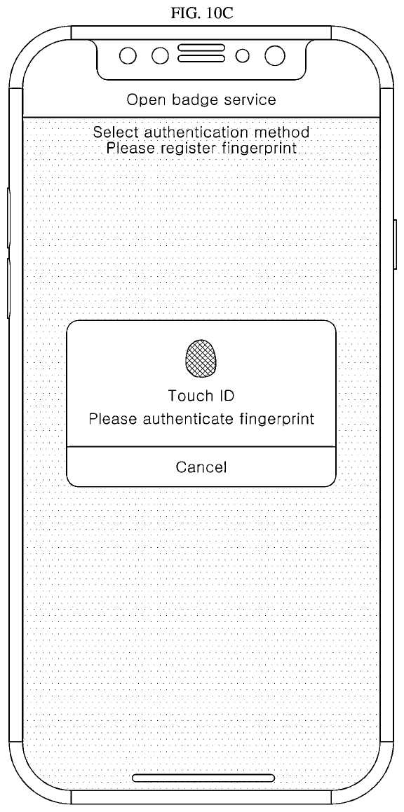

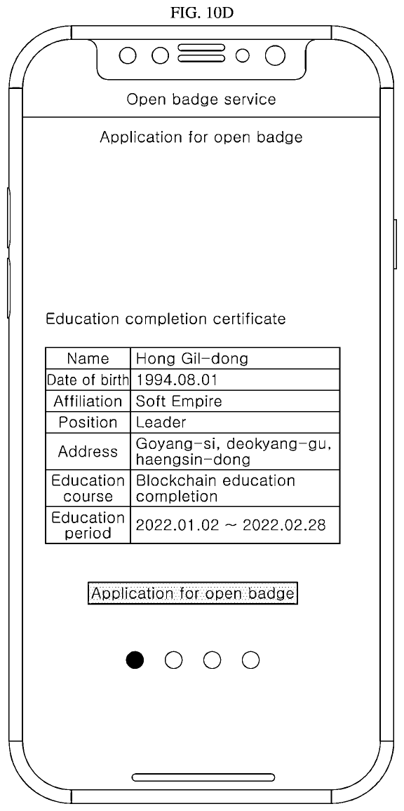

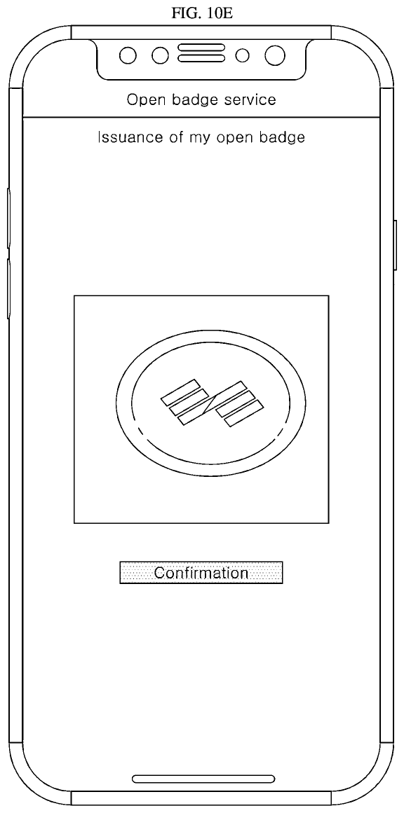

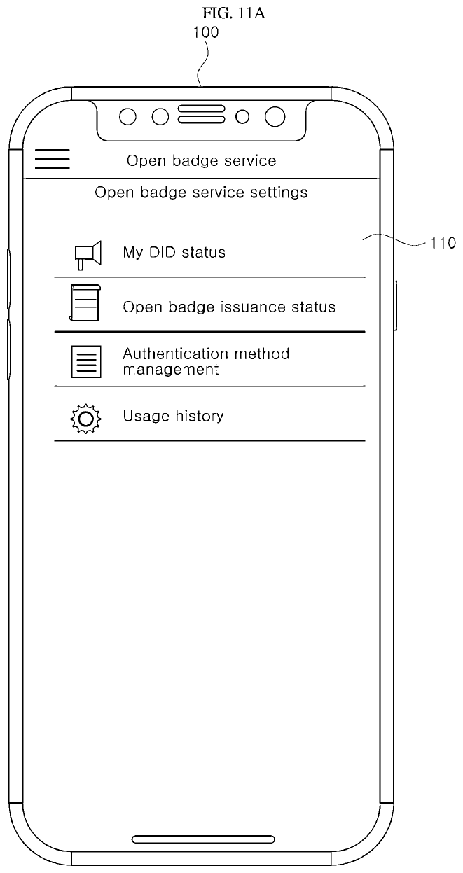

FIGS. 10A to 10E are drawings showing a specific operation of issuing an open badge in a method for providing an authentication service by using an open badge linked to blockchain-based academic achievement, according to an embodiment of the present disclosure.

Referring to FIGS. 10A to 10E, as illustrated in FIG. 10A, a user launches a separate web page or application through the user terminal 100 to receive an authentication service by using an open badge linked to blockchain-based academic achievement. Accordingly, as illustrated in FIG. 10B, an activated button may be displayed on the display 110 of the user terminal 100 so as to request DID issuance or open badge issuance for the corresponding user.

As illustrated in FIG. 10C, when the user selects an open badge issuance application button, user authentication (DID authentication) may be performed by selecting one of a plurality of authentication methods.

Accordingly, at least one open badge issuable to the user may be displayed on the display 110 of the user terminal 100. As illustrated in FIG. 10D, history data for a certificate of education may be displayed on the display 110 when the user selects an open badge for the certificate of education among the at least one issuable open badge.

As illustrated in FIG. 10E, the open badge for the certificate of education may be completely issued when the user selects an open badge application button based on the screen.

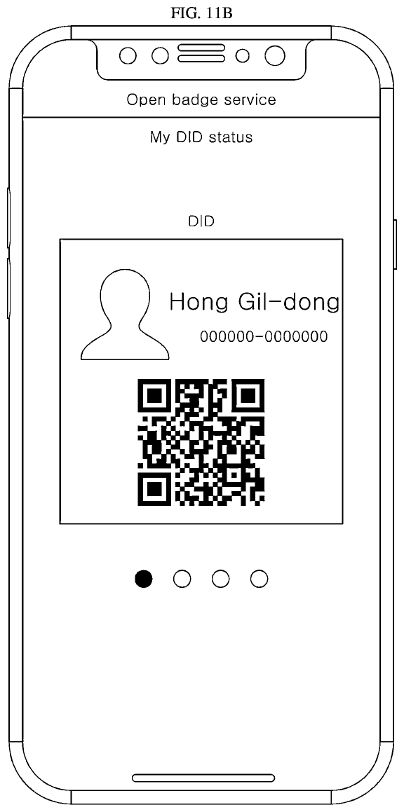

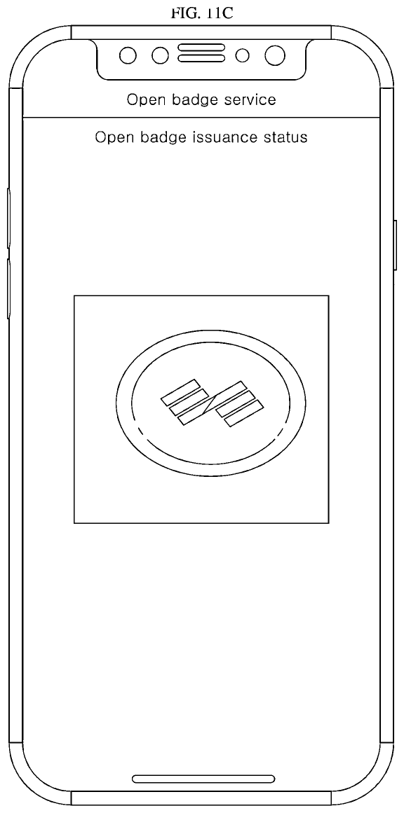

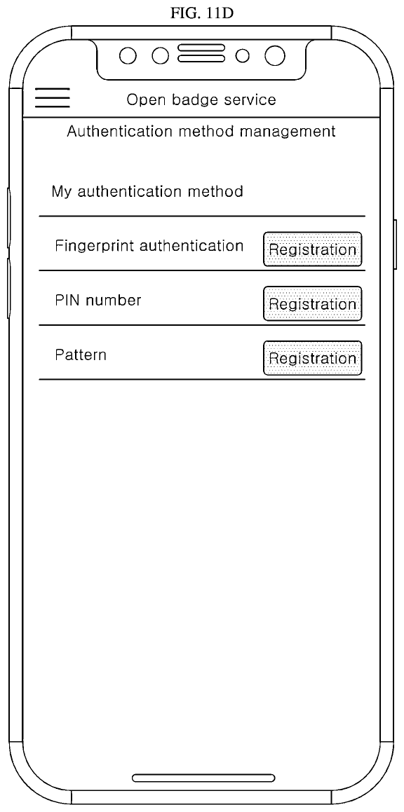

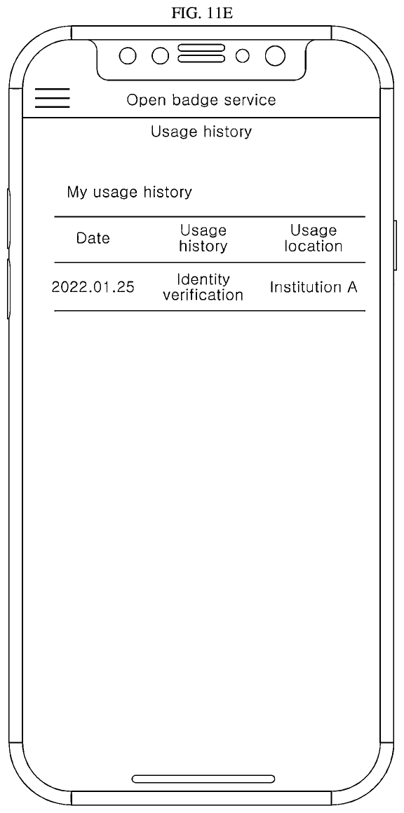

FIGS. 11A to 11E are drawings showing an example of a screen displayed on a display of a user terminal so as to identify a status of a DID electronic wallet of a corresponding user created on a blockchain, according to an embodiment of the present disclosure.

Referring to FIGS. 11A to 11E, as illustrated in FIG. 11A, as a user launches a separate web page or application through the user terminal 100 to use an authentication service by using a blockchain DID-based open badge, a user interface may be configured to set an environment for providing the authentication service.

As illustrated in FIG. 11B, when desiring to identify his/her DID status, the user may identify at least one DID issued to him/her by selecting the corresponding item (my DID status). Moreover, as illustrated in FIG. 11C, when desiring to identify his/her open badge issuance status, the user may identify at least one open badge issued to him/her by selecting the corresponding item (an open badge issuance status). Furthermore, as illustrated in FIG. 11D, when desiring to set or change an authentication method for authenticating himself/herself, a screen may be configured to register authentication in each of a plurality of available authentication methods, by selecting the corresponding item (authentication method management). Finally, as illustrated in FIG. 11E, when desiring to identify a usage history, the screen may be configured such that the user may identify the history of using an authentication service, by selecting the corresponding item (a usage history).

Accordingly, as illustrated in FIG. 11B, an activated button may be displayed on the display 110 of the user terminal 100 so as to request DID issuance or open badge issuance for the corresponding user.

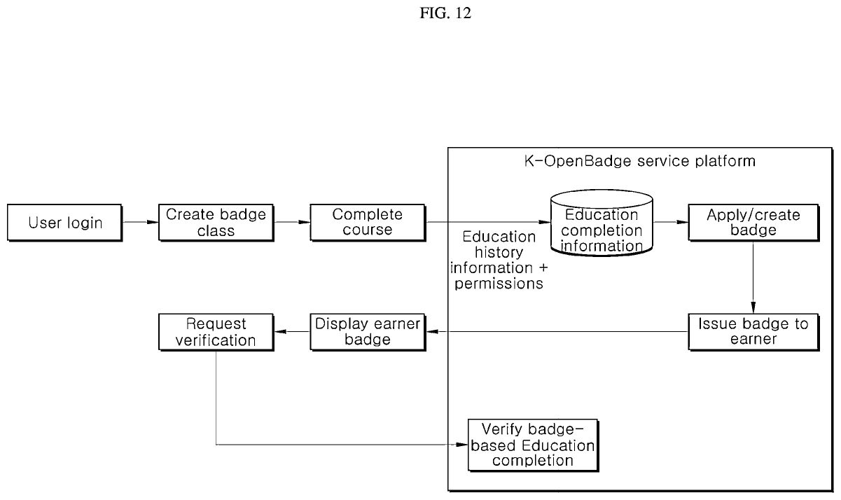

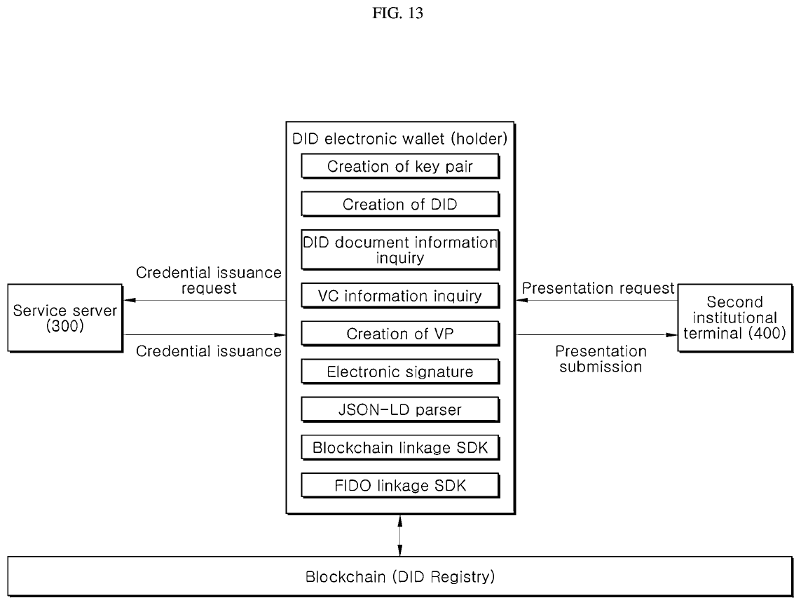

FIG. 12 is a diagram showing an example of utilizing an open badge linked to blockchain-based academic achievement, according to an embodiment of the present disclosure.

Because an open badge provides the following powerful features that differentiate the open badge from other types of digital badges, the open badge is being widely adopted in an education sector.

For example, lectures may be created at schools or institutions and then badges may be obtained under conditions. A user (learner) may attend a lecture and then may obtain a badge. The obtained badge may be collected and managed to provide a learning profile (e-portfolio) service.

An open badge may be issued based on IMS global open badge international standard 2.0. This specification refers to a method of packaging information about performance, including the packaged information in a portable image file as an open badge, and setting up resources for verification.

The open badge is expressed in JSON-LD in a method of displaying data to improve understanding in a variety of contexts, and may include documents other than purposes contemplated herein. The open badge may utilize functions of JSON-LD for internationalization/localization, entity identification with unique IRI, and extensibility.

In the meantime, the open badge is used by thousands of issuers around the world. A user of the corresponding badge may issue internationalized and multilingual badges by using various languages.

FIG. 13 is a diagram showing a structure of a DID electronic wallet registered in a blockchain, according to an embodiment of the present disclosure.

Referring to FIG. 13, a DID electronic wallet may be designed in consideration of expansion to accommodate various verifiable credentials.

In other words, it may perform encryption/decryption and access control functions for safe storage of verifiable credential information (VC) and DID private keys and for use as verifiable presentation (VP). In this way, the user may utilize and spread an open badge issued to him/her based on an online/offline.

To ensure safe use and utilization of the DID electronic wallet, the service server 300 may be equipped with user authentication and convenience functions.

As shown in FIG. 13, the service server 300 and the second institutional terminal 400 perform issuance or verification on the open badge based on the user's DID electronic wallet registered in the blockchain.

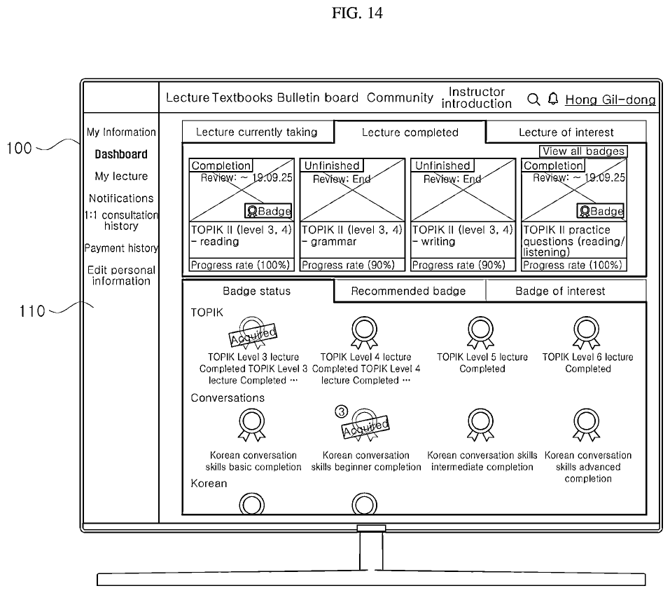

FIG. 14 is a drawing showing an example of a dashboard for a corresponding user displayed in a portfolio format on a display of a user terminal, according to an embodiment of the present disclosure.

As shown in FIG. 14, a user may identify his/her own DID status by launching a web page or platform through his/her terminal (i.e., the user terminal 100). In this case, the DID status may be implemented in a portfolio format on a separately configured dashboard and may be displayed on the display 110.

In particular, enrollment information about at least one lecture that the user is taking may be displayed. In the case, a completion status for each lecture may also be displayed. Besides, open badges issued for each lecture that the user has completed may be placed and classified for each category.

However, a screen configuration of FIG. 14 is only an example and is not limited to information to be placed or the format thereof.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

The stored medium refers not to a medium, such as a register, a cache, or a memory, which stores data for a short time but to a medium that stores data semi-permanently and is read by a device. Specifically, for example, the stored media include, but are not limited to, ROM, RAM, CD-ROM, magnetic tape, floppy disk, optical data storage device, and the like. That is, the program may be stored in various recording media on various servers, which the computer may access, or in various recording media on the computer of the user. Further, the media may be distributed in computer systems connected over a network such that codes readable by the computer are stored in a distributed manner.

Steps or operations of the method or algorithm described with regard to an embodiment of the present disclosure may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the present disclosure pertains.

Although an embodiment of the present disclosure are described with reference to the accompanying drawings, it will be understood by those skilled in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

According to the above-mentioned problem solving means of the present disclosure, it is possible to reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

In the meantime, according to an embodiment of the present disclosure, it is possible to allow a user to easily check the user's fragmented history data by integrating and managing at least one open badge issued to the user, and to allow the user to post the fragmented history data to at least one SNS, thereby quickly and easily utilize the history data for employment or advancement.

Effects of the present disclosure are not limited to the effects mentioned above, and other effects not mentioned will be clearly understood by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. An authentication service providing system by using an open badge linked to a blockchain-based academic achievement, the system comprising:
a first institutional terminal configured to provide a learning service to a user terminal, and to create or update history information about a corresponding user by receiving learning performance result information from the user terminal;
the user terminal configured to perform learning through a learning service provided by the first institutional terminal, to store an open badge issued as making a request for open badge issuance for the learning to a service server, and to request qualification recognition by submitting the stored open badge to a second institutional terminal;
the service server configured to determine whether the corresponding user has an issuance qualification for the open badge requested to be issued, when the open badge issuance is requested from the user terminal, to determine whether to issue the open badge, and to record and manage the issued open badge in a decentralized identifiers (DID) electronic wallet of the corresponding user registered in a blockchain; and
the second institutional terminal configured to determine whether the corresponding user is qualified for the learning, by requesting the service server to verify a submitted open badge when the stored open badge is submitted from the user terminal,
wherein the service server recommends other learning, which is related to the open badge previously issued to the user, to the user terminal such that the user is capable of receiving an additional open badge,
wherein the open badge includes necessary metadata and optional metadata,
wherein the necessary metadata includes verification uniform resource locator (URL) information, and
wherein the optional metadata includes evidence URL information, information about a possibility of integration with another badge, other service purpose information, information about prerequisite learning requirements for course registration, information about connectivity with another course, and information about a characteristic of a qualification created by integration with another course.

2. The system of claim 1, wherein the open badge is issued by identifying at least one of the corresponding user's learning chunks, proficiency, competency, and talent for the learning, and is posted on at least one social network service (SNS) selected by the user terminal.

3. The system of claim 1, wherein the service server is linked to the first institutional terminal based on an application programming interface (API) to perform at least one of DID user registration, open badge issuance, and DID verification for the corresponding user.

4. The system of claim 3, wherein when a DID verification request for the issued open badge is received from the second institutional terminal, the service server performs DID verification on the issued open badge based on the DID electronic wallet of the corresponding user registered in the blockchain.

5. The system of claim 3, wherein when performing the DID verification, the service server verifies badge issuance data by using a hash value of the issued open badge and a hash value of an open badge previously registered in the blockchain.

6. The system of claim 5, wherein the service server performs verification on the issued open badge based on a public key used to sign an assertion that is digitally signed in the issued open badge.

7. The system of claim 6, wherein the first institutional terminal includes user information about the corresponding user and the history information, and
wherein the badge issuance data is extracted from the history information.

8. The system of claim 1, wherein when a DID user registration request is received from the user terminal, the service server verifies user identity through one of a plurality of authentication methods while issuing an initial distributed ID to the corresponding user.

9. The system of claim 8, wherein the plurality of authentication methods includes at least one of biometric authentication, a PIN number, and a pattern.

10. A method for providing an authentication service by using an open badge linked to blockchain-based academic achievement, the method, which is performed by a device, comprising:
when a corresponding user completely performs learning based on a learning service provided by a first institutional terminal, transmitting, by a user terminal, learning performance result information about the learning to the first institutional terminal;
creating or updating, by the first institutional terminal, history information about the corresponding user based on the learning performance result information;
when an open badge issuance request for the learning is received from the user terminal, determining, by a service server, whether the corresponding user has an issuance qualification for an open badge requested to be issued, through the first institutional terminal;
when the determination result indicates that the corresponding user has the issuance qualification for the open badge requested to be issued, issuing, by the service server, an open badge for the learning based on badge issuance data for the corresponding user;
recording and managing, by the service server, the issued open badge in a DID electronic wallet of the corresponding user registered on a blockchain; and
when a verification request for the issued open badge is received from a second institutional terminal, performing, by the service server, verification on the issued open badge based on the DID electronic wallet of the corresponding user,
wherein the issuing of the open badge includes:
recommending, by the service server, other learning, which is related to an open badge previously issued to the user, to the user terminal such that the user is capable of receiving an additional open badge,
wherein the open badge includes necessary metadata and optional metadata,
wherein the necessary metadata includes verification URL information, and
wherein the optional metadata includes evidence URL information, information about a possibility of integration with another badge, other service purpose information, information about prerequisite learning requirements for course registration, information about connectivity with another course, and information about a characteristic of a qualification created by integration with another course.
